(19) United States
(12) Patent Application Publication
(10) Pub. No.: US 2025/0149021 A1
(43) Pub. Date: May 8, 2025

(54) ELECTRONIC DEVICE AND CONTROL METHOD THEREFOR

(71) Applicant: Samsung Electronics Co., Ltd., Suwon-si (KR)

(72) Inventors: Kihyun CHOO, Suwon-si (KR); Sangjun PARK, Suwon-si (KR); Joohyung LEE, Suwon-si (KR); Seongkyu MUN, Suwon-si (KR)

(21) Appl. No.: 19/016,520

(22) Filed: Jan. 10, 2025

Related U.S. Application Data
(63) Continuation of application No. PCT/KR2023/010126, filed on Jul. 14, 2023.

(30) Foreign Application Priority Data
Aug. 31, 2022 (KR) 10-2022-0110100

(51) Int. Cl. G10L 13/033; G10L 25/90

(52) U.S. Cl. CPC G10L 13/0335; G10L 25/90

(57) ABSTRACT

Disclosed is an electronic device and a control method therefor. The electronic device according to an embodiment includes: memory storing at least one instruction and at least one processor, comprising processing circuitry, individually and/or collectively, configured to execute the at least one instruction, and to: identify a target pitch shift value for shifting a pitch of voice data, divide the identified target pitch shift value into a first pitch shift value and a second pitch shift value, identify a pitch shift embedding value based on the first pitch shift value, obtain second voice data by updating a feature of a pitch of first voice data based on the second pitch shift value, identify a pitch embedding value based on a pitch of the obtained second voice data, and obtain third voice data to which the pitch of the first voice data is shifted based on the pitch shift embedding value and the pitch embedding value.

### CROSS-REFERENCE TO RELATED APPLICATIONS

This application is a continuation of International Application No. PCT/KR2023/010126 designating the United States, filed on Jul. 14, 2023, in the Korean Intellectual Property Receiving Office and claiming priority to Korean Patent Application No. 10-2022-0110100, filed on Aug. 31, 2022, in the Korean Intellectual Property Office, the disclosures of each of which are incorporated by reference herein in their entireties.

### BACKGROUND

### Field

The disclosure relates to an electronic device and a control method therefor and for example, to an electronic device for shifting or controlling a pitch of voice data and a control method therefor.

### Description of Related Art

Voice data includes phoneme information corresponding to an utterance content and prosody information corresponding to intonation and stress. The prosody information includes a magnitude of a sound, a height of the sound, and a length of the sound, wherein the height of the sound is referred to as a pitch and a unit of the pitch is Hz.

Conventionally, synthetic speech data was obtained by converting a pitch of voice data using an acoustic model or a vocoder including an encoder, a decoder, an attention module, a pitch prediction module, a pitch control module, a post-processing module, etc.

### SUMMARY

An electronic device according to an example embodiment of the disclosure includes: memory storing at least one instruction and at least one processor, comprising processing circuitry, individually and/or collectively, configured to execute the at least one instruction, and to: identify a target pitch shift value for shifting a pitch of voice data, divide the identified target pitch shift value into a first pitch shift value and a second pitch shift value, identify a pitch shift embedding value based on the first pitch shift value, obtain second voice data by updating a feature of a pitch of first voice data based on the second pitch shift value, identify a pitch embedding value based on a pitch of the obtained second voice data, and obtain third voice data to which the pitch of the first voice data is shifted based on the pitch shift embedding value and the pitch embedding value.

At least one processor, individually and/or collectively, may be configured to divide the target pitch shift value into the first pitch shift value and the second pitch shift value based on a pitch shift embedding table.

At least one processor, individually and/or collectively, may be configured to: identify an index value closest to the target pitch shift value among at least one index value included in the pitch shift embedding table as the first pitch shift value and identify a difference between the identified first pitch shift value and the target pitch shift value as the second pitch shift value.

The first pitch shift value may be an integer value and the second pitch shift value may be a decimal value.

At least one processor, individually and/or collectively, may be configured to: obtain metadata based on the pitch shift embedding value and the pitch embedding value, encode the metadata in a frame unit, and obtain the third voice data by decoding the encoded metadata in a sample unit.

At least one processor, individually and/or collectively, may be configured to: identify input data of a pitch shift embedding model based on feature information of the first voice data and the target pitch shift value, identify output data of the pitch shift embedding model based on the third voice data, identify a loss of the pitch shift embedding model based on the input data and the output data, and learn the pitch shift embedding model and the pitch shift embedding table based on the input data, the output data, and the loss.

At least one processor, individually and/or collectively, may be configured to: extract feature information from the first voice data, obtain fourth voice data by augmenting the pitch of the first voice data based on the target pitch shift value, extract feature information from the obtained fourth voice data, and identify input data of the pitch shift embedding model based on the feature information extracted from the first voice data and the feature information extracted from the fourth voice data.

The feature information of the first voice data may include cepstrum, the pitch, or correlation.

According to an example embodiment of the disclosure, a method of controlling an electronic device includes: identifying a target pitch shift value for shifting a pitch of voice data, dividing the identified target pitch shift value into a first pitch shift value and a second pitch shift value, identifying a pitch shift embedding value based on the first pitch shift value, obtaining second voice data by updating a feature of a pitch of first voice data based on the second pitch shift value, identifying a pitch embedding value based on a pitch of the obtained second voice data, and obtaining third voice data to which the pitch of the first voice data is shifted based on the pitch shift embedding value and the pitch embedding value.

The dividing may include dividing the target pitch shift value into the first pitch shift value and the second pitch shift value based on a pitch shift embedding table.

The dividing may include: identifying an index value closest to the target pitch shift value among at least one index value included in the pitch shift embedding table as the first pitch shift value and identifying a difference between the identified first pitch shift value and the target pitch shift value as the second pitch shift value.

The first pitch shift value may be an integer value and the second pitch shift value may be a decimal value.

The obtaining the third voice data may include: obtaining metadata based on the pitch shift embedding value and the pitch embedding value, encoding the metadata in a frame unit, and obtaining the third voice data by decoding the encoded metadata in a sample unit.

The method may further include learning a pitch shift embedding model, wherein the learning may include: identifying input data of the pitch shift embedding model based on feature information of the first voice data and the target pitch shift value, identifying output data of the pitch shift embedding model based on the third voice data, identifying a loss of the pitch shift embedding model based on the input data and the output data, and learning the pitch shift embedding model and the pitch shift embedding table based on the input data, the output data, and the loss.

The learning may include: obtaining fourth voice data by augmenting the pitch of the first voice data based on the target pitch shift value, extracting feature information from the obtained fourth voice data, and identifying input data of the pitch shift embedding model based on the feature information extracted from the first voice data and the feature information extracted from the fourth voice data.

The feature information of the first voice data may include cepstrum, the pitch, or correlation.

A non-transitory computer-readable recording medium storing computer instructions that when executed by at least one processor, comprising processing circuitry, of an electronic device, individually and/or collectively, cause the electronic device to: identify a target pitch shift value for shifting a pitch of voice data, divide the identified target pitch shift value into a first pitch shift value and a second pitch shift value, identify a pitch shift embedding value based on the first pitch shift value, obtain second voice data by updating a feature of a pitch of first voice data based on the second pitch shift value, identify a pitch embedding value based on a pitch of the obtained second voice data, and obtain third voice data to which the pitch of the first voice data is shifted based on the pitch shift embedding value and the pitch embedding value.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a block diagram illustrating the related art related to an electronic device;

FIG. 3 is a block diagram illustrating an example operation of an electronic device according to various embodiments;

FIG. 4A is a diagram illustrating an example method of dividing a target pitch shift value into a first pitch shift value and a second pitch shift value based on a pitch shift embedding table and at least one index value included therein according to various embodiments;

FIG. 4B is a diagram illustrating an example method of dividing a target pitch shift value into a first pitch shift value and a second pitch shift value based on a pitch shift embedding table and at least one index value included therein according to various embodiments;

FIG. 5A is a spectrogram of voice data of which a pitch is shifted by an electronic device according to the related art;

FIG. 5B is a spectrogram of voice data of which a pitch is shifted by an electronic device according to various embodiments;

FIG. 6 is a diagram illustrating a pitch shift embedding model controlled by an electronic device according to various embodiments;

FIG. 7 is a diagram illustrating learning of a pitch shift embedding model controlled by an electronic device according to various embodiments; and

FIG. 8 is a flowchart illustrating an example operation of an electronic device according to various embodiments.

### DETAILED DESCRIPTION

Various embodiments of the disclosure may be modified in various and different forms and may have various examples, wherein examples are illustrated in the drawings and specifically explained in the detailed description. However, it should be understood that disclosure is not intended to limit the scope of the disclosure to a specific example but includes all modifications, equivalents, and/or alternatives of various embodiments of the disclosure. With respect to the description of the drawings, similar components may be designated by similar reference numerals.

In case it is determined that in describing the disclosure, detailed explanation of related known functions or features may unnecessarily confuse the gist of the disclosure, the detailed explanation may be omitted.

In addition, the various embodiments below may be modified in various and different forms and the scope of the technical idea of the disclosure is not limited to the various embodiments below. Rather, these embodiments are provided to make the disclosure more sufficient and complete.

The terms used in the disclosure are used to explain various embodiments and are not intended to limit the scope of the disclosure. A singular expression may include a plural expression, unless clearly differently defined in the context.

In the disclosure, the expressions such as “have,” “may have,” “include” or “may include” denote the existence of such characteristics (e.g. elements such as a numerical value, a function, an operation, or a part) and do not exclude the existence of additional characteristics.

In the disclosure, the expressions “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expressions “1st”, “2nd”, “first”, “second”, or the like used in the disclosure may be used to describe various elements regardless of any order and/or degree of importance. Also, such expressions are used only to distinguish one element from another element and are not intended to limit the relevant elements.

The description that one element (e.g. a first component) is “(operatively or communicatively) coupled with/to” or “connected to” another element (e.g. a second component) should be interpreted such that the one element may be directly coupled to the another element or the one element may be coupled to the another element through the other element (e.g.: a third component).

The description that one element (e.g. a first component) is “directly coupled” or “directly connected” to another element (e.g. a second component) may be interpreted that there is no element (e.g. a third component) in-between.

The expression “configured to (or set to)” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily refer to a device being “specifically designed to” in terms of hardware.

Under some circumstances, the expression “a device configured to” may refer, for example, to the device “is capable of” performing an operation together with another device or part. For example, the phrase “a processor configured to (set to) perform A, B, and C” may refer to a dedicated processor for performing the relevant operation (e.g. an embedded processor) or a generic-purpose processor that may perform the relevant operation by executing one or more software programs stored in a memory device (e.g. a CPU or an application processor).

In an embodiment of the disclosure, ‘module’ or ‘part’ may perform at least one function or operation and may be implemented as hardware or software, or as a combination of hardware and software. In addition, a plurality of ‘modules’ or ‘parts’ may be integrated into at least one module and implemented as at least one processor excluding ‘a module’ or ‘a part’ that needs to be implemented as specific hardware. Various elements and areas in the drawings were schematically illustrated. Accordingly, the technical idea of the disclosure is not limited by the relative sizes or intervals illustrated in the appended drawings.

Hereinafter, with reference to the appended drawings, various example embodiments according to the disclosure are described in greater detail.

According to the disclosure, an electronic device 100 may be a vocoder. The vocoder may refer, for example, to a device comprising circuitry configured to generate a voice signal by utilizing feature information of voice data. A function of shifting or controlling a feature about a pitch among feature information of the voice data may be added to the vocoder. The electronic device 100 is not limited to the vocoder and may be various electronic devices 100 by which a pitch of the voice data may be shifted.

The electronic device 100 does not necessarily independently perform an operation and may perform one or more operations by connecting to an external device or a server.

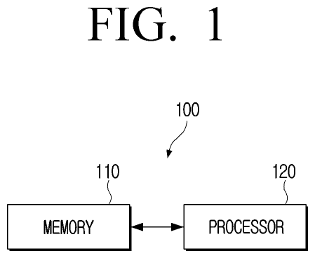

FIG. 1 is a block diagram illustrating an example configuration of an electronic device 100 according to various embodiments.

With reference to FIG. 1, the electronic device may include memory 110 and a processor (e.g., including processing circuitry) 120. The disclosure is not limited thereto and the electronic device may additionally include various components of the device such as a mike, a speaker, a communication interface, or a user interface required for an operation of the electronic device.

Memory 110 may store temporarily or non-temporarily various programs or data and transmit the stored information to a processor 120 according to a call of the processor 120. Also, the memory 110 may store various information required for an operation, processing, a control operation, or the like of the processor 120 as an electronic format. The memory 110 may include at least one of, for example, a main memory unit and an auxiliary memory unit. The main memory unit may be implemented using a semiconductor storage medium such as ROM and/or RAM. ROM may include, for example, a general ROM, EPROM, EEPROM, and/or MASK-ROM. RAM may include, for example, DRAM and/or SRAM. The auxiliary memory may be implemented using at least one storage medium that may permanently or semi-permanently store data such as a flash memory 110 device, a secure digital (SD) card, a solid state drive (SSD), a hard disc drive (HDD), a magnetic drum, a compact disk (CD), an optical medium such as a DVD or a laser disk, a magnetic tape, a magneto −optical disk and/or a floppy disk.

The memory 110 may store various instructions required for an operation of the electronic device 100 and various information related to an operation of the electronic device 100.

The memory 110 may store, for example, voice data and feature information including the voice data. Here, the feature information of the voice data may be, for example, cepstrum, a pitch, or correlation but the feature information of the voice data is not limited thereto. Besides, it may include various information indicating a voice feature such as a spectrogram of the voice data.

The memory 110 may store a target pitch shift value for shifting a pitch of the voice data. Also, the memory 110 may store a first pitch shift value and a second pitch shift value into which the target pitch shift value is divided. The memory 110 may store a pitch shift embedding value corresponding to each pitch shift value and a pitch embedding value.

The memory 110 may store a pitch shift embedding table and at least one index value included therein.

The memory 110 may store metadata generated in a process of generating voice data to which a pitch is shifted and may store information related to an encoder and a decoder related to processing of the metadata.

The memory 110 may store a pitch shift embedding model and may store an input value of the pitch shift embedding model, an output value thereof, information about a loss, or the like.

The memory 110 may store information about pitch augmentation of the voice data.

The processor 120 may include various processing circuitry and controls overall operations of the electronic device 100. For example, the processor 120 is connected to a configuration of the electronic device 100 including the memory 110 as aforementioned and may overall control operations of the electronic device 100 by executing at least one instruction stored in the memory 110 as aforementioned. In particular, the processor 120 may be implemented as not only one processor 120 but also a plurality of processors 120.

The processor 120 may be implemented in various forms. For example, one or more processors 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 120 may control one or any combination of other components of the electronic device 100 and may perform an operation related to a communication or data processing. The one or more processors 120 may execute one or more programs or instructions stored in the memory 110. For example, the one or more processors 120 may execute one or more instructions stored in the memory 110, thereby performing a method according to an embodiment of the disclosure. The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

If the method according to an embodiment of the disclosure includes a plurality of operations, the plurality of operations may be performed by one processor 120 and may be performed by a plurality of processors 120. For example, when a first operation, a second operation, and a third operation are performed by a method according to an embodiment, all of the first operation, the second operation, and the third operation may be performed by a first processor and also, the first operation and the second operation may be performed by the first processor (e.g. a generic-purpose processor) and the third operation may be performed by the second processor 120 (e.g. an artificial intelligence (AI) dedicated processor).

The one or more processors 120 may be implemented as a single core processor including one core and may be also implemented as one or more multicore processors including a plurality of cores (e.g. homogeneous multicores or heterologous multicores). If the one or more processors 120 are implemented as the multicore processors, each of the plurality of cores included in the multicore processor may include the memory 110 inside the processor 120 such as on-chip memory and a common cache shared by the plurality of cores may be included in the multicore processor. Also, each of the plurality of cores included in the multicore processor (or part of the plurality of cores) may be performed by reading program instructions for independently implementing a method according to an embodiment of the disclosure and also, all (or part) of the plurality of cores are connected to read and perform program instructions for implementing the method of various embodiments of the disclosure.

If the method according to various embodiments of the disclosure includes a plurality of operations, the plurality of operations may be performed by one core among the plurality of cores included in the multicore processor and may be performed by the plurality of cores. For example, when a first operation, a second operation, and a third operation are performed by a method according to an embodiment, all of the first operation, the second operation, and the third operation may be performed by a first core included in the multicore processor and also, the first operation and the second operation may be performed by the first core included in the multicore processor and the third operation may be performed by a second core included in the multicore processor.

In embodiments of the disclosure, the processor 120 may refer, for example, to one or more processors 120 and a system on chip on which other electronic parts are integrated, a single core processor, a multicore processor, or a core included in the single core processor or the multicore processor, wherein the core may be implemented as the CPU, the GPU, the APU, the MIC, the DSP, the NPU, the hardware accelerator, or the machine learning accelerator but embodiments of the disclosure are not limited thereto.

The processor 120 may include a target pitch shift value division module, a pitch shift embedding module, a pitch shift module, a feature update module, a vector concatenate module, or the like, each of which may include various circuitry and/or executable program instructions.

The processor 120 may identify the target pitch shift value for shifting a pitch of the voice data. The processor 120 may divide the target pitch shift value identified through the target pitch shift value division module into the first pitch shift value and the second pitch shift value.

The processor 120 may identify a pitch shift embedding value based on the first pitch shift value through the pitch shift embedding module.

The processor 120 may obtain the second voice data by updating a feature about a pitch of the first voice data based on the second pitch shift value through the pitch shift module and the feature update module. Here, the first voice data may refer, for example, to an original voice or feature information of the voice (a feature sequence) and the second voice data may refer, for example, to feature information obtained by updating a feature about a pitch of the first voice data.

The processor 120 may identify a pitch embedding value based on a pitch of the second voice data obtained through the pitch shift module and the feature update module.

The processor 120 may obtain third voice data to which a pitch of the first voice data is shifted based on the pitch shift embedding value and the pitch embedding value through the vector concatenate module. Here, the third voice data may be a synthesized voice. The disclosure is not limited thereto and it may be feature information of the synthesized voice such as the first voice data and the second voice data.

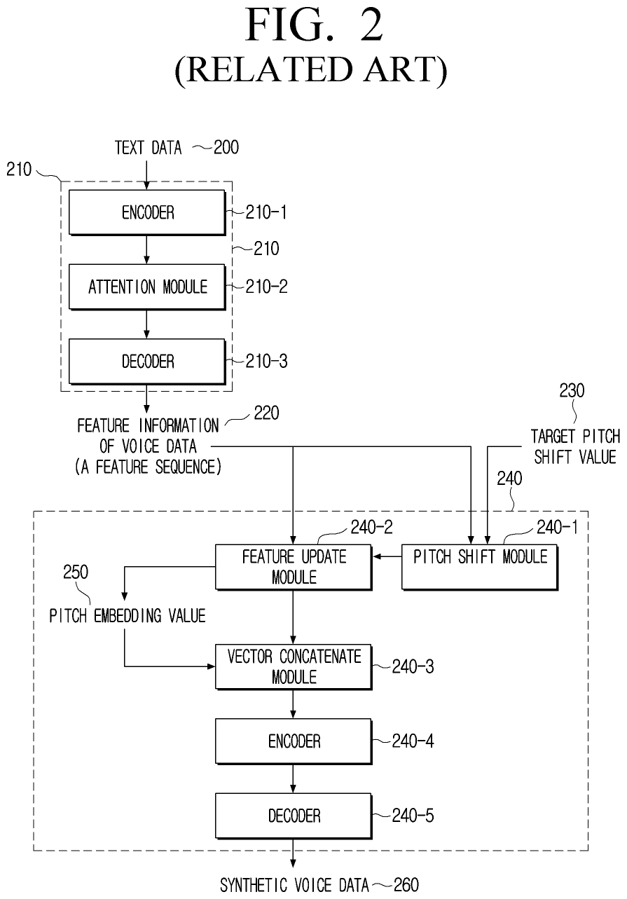

For example, a control operation of the processor 120 is described in greater detail below with reference to FIGS. 2 to 7.

FIG. 2 is a block diagram illustrating the related art related.

With reference to FIG. 2, a configuration of the electronic device 100 for shifting a pitch according to the related art is largely configured of an acoustic model 210 and a vocoder 240.

The acoustic model 210 may include a model outputting feature information including prosody if a text or phoneme is input. For example, the acoustic model may be a Text-to −Speech (TTS) model but it is not limited thereto and may include various models which may output feature information 220 of the voice data.

The acoustic model 210 may include a configuration such as an encoder 210-1 which encodes a signal, an attention module 210-2 which outputs attention information for identifying which part has the highest relevance with data to be output by the decoder next among the relevant information if data output from the encoder is input, or a decoder 210-3 which shifts the data encoded by the encoder to a signal again. Here, the encoder 210-1 may be a text encoder which outputs data to which a signal related to the text is encoded if the text is input.

If text data 200 is input to the acoustic model 210, feature information 220 of the voice data (a feature sequence) finally corresponding to the relevant text data 200 may be output.

The feature information 222 of the voice data output from the acoustic model 210 may be input to the vocoder 240 generating the voice data. The vocoder 240 may shift or control a feature related to a pitch among feature information of the voice. If the feature information 220 of the voice data is input to the vocoder 240, a target pitch shift value 230 which is a target value of a pitch desired to be shifted may be input at the same time.

A pitch shift value 240-1 of the vocoder 240 may shift a pitch of the voice data based on the input target pitch shift value and may transfer information related to a pitch shift of the voice data to a feature update module 240-2 which may update a feature of the voice data.

The vocoder 240 may update the feature information 220 of the voice data through the feature update module 240-2 based on the target pitch shift value 230 and the vocoder 240 may obtain a pitch embedding value 250.

The pitch embedding value 250 may refer, for example, to a vector value on a virtual space corresponding to a pitch shifted by the target pitch shift value 230.

The vocoder 240 may combine a vector value corresponding to the updated feature information of the voice data output from the feature update module 240-2 through a vector concatenate module 240-3, and the pitch embedding value 250.

The vocoder 240 may encode a vector value of the voice data output from the vector concatenate module 240-3 through an encoder 240-4, shift it to a signal again through a decoder 240-5, and finally output synthetic voice data 260.

The method of shifting a pitch according to the related art as aforementioned has difficulties such that deterioration of the voice data occurs or an exact pitch shift is difficult when shifting the pitch using the target pitch shift value 230 and the pitch shift module 240-1 having a simple structure.

The method of shifting a pitch using the acoustic model has a problem that a maintenance cost is relatively high.

There is a need for searching for a method of using the vocoder rather than the acoustic model, by which a delay does not excessively occur in a pitch shift process, and of shifting a pitch exactly throughout a wide range from a low sound to a high sound.

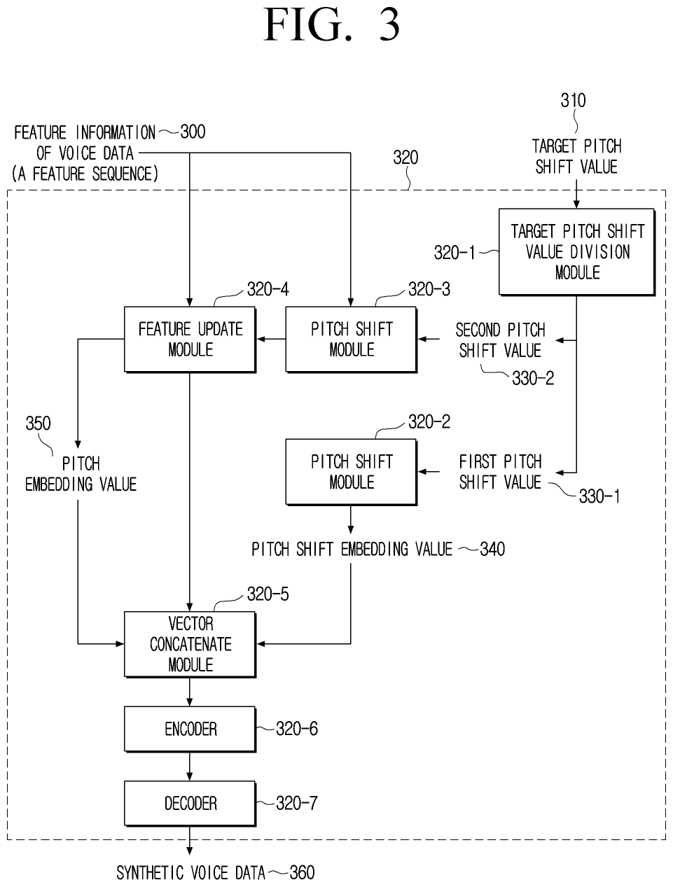

Therefore, a method for improving a structure and a performance of a pitch shift method using the vocoder 240 among components included in the related art is provided, wherein example operations may be described together in greater detail below with reference to FIG. 3.

FIG. 3 is a block diagram illustrating an example operation of an electronic device 100 according to various embodiments.

With reference to FIG. 3, the processor 120 may receive or identify feature information 300 of the voice data and a target pitch shift value 310.

The processor 120 may receive the feature information 300 of the voice data and the target pitch shift value 310 by performing a wired/wireless communication connection with an external device or a server through a wired/wireless communication interface (not shown) or may receive an input with respect to the feature information 300 of the voice data and the target pitch shift value 310 through the user interface (not shown).

The processor 120 may divide the target pitch shift value 310 received through the target pitch shift value division module 320-1 into the first pitch shift value 330-1 and the second pitch shift value 330-2. The processor 120 may perform any operation (a vector operation, four fundamental arithmetic operations, a log operation, a differential operation, etc.) for dividing the target pitch shift value 310 into the first pitch shift value 330-1 and the second pitch shift value 330-2.

The target pitch shift value 310 may be a value of any real number corresponding to a pitch value desired to be shifted, wherein the target pitch shift value 310 may be derived if any operation is performed using the first pitch shift value 330-1 and the second pitch shift value 330-2. For example, if the target pitch shift value 310 is −2.8, the first pitch shift value 330-1 may be −3 and the second pitch shift value 330-2 may be 0.2. The disclosure is not limited thereto and the first pitch shift value 330-1 and the second pitch shift value 330-2 may have values of various real numbers identifying pitch shift values.

The processor 120 may divide the target pitch shift value into the first pitch shift value 330-1 and the second pitch shift value 330-2 through the target pitch shift value division module 320-1 based on the pitch shift embedding table. The pitch shift embedding table may include at least one index value corresponding to a change amount of a pitch desired to be shifted.

The at least one index value included in the pitch shift embedding table may correspond to a specific discontinuous value. For example, the index value included in the pitch shift embedding table may be an integer value of such as “−3, −2, −1, 0, 1, 2, or 3”. The disclosure is not limited thereto and the at least index value included in the pitch shift embedding table may have various values corresponding to a pitch desired to be shifted.

For example, the processor 120 may identify an index value closest to the target pitch shift value 310 among at least one index value included in the pitch shift embedding table through the target pitch shift value division module 320-1 as the first pitch shift value 330-1 and may identify a difference between the identified first pitch shift value 330-1 and the target pitch shift value 310 as the second pitch shift value 330-2.

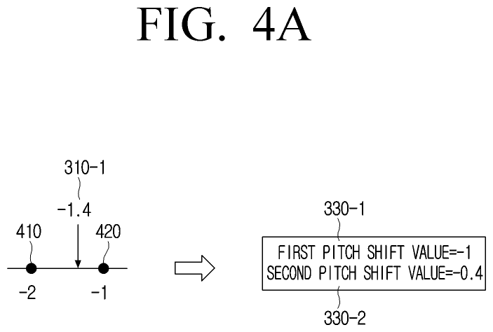

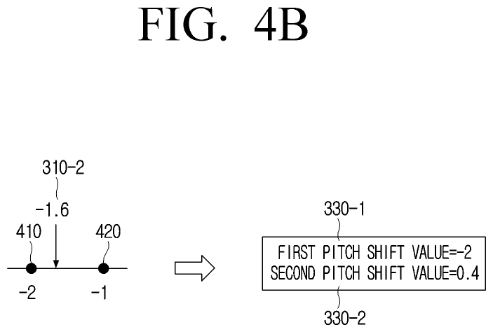

FIGS. 4A and 4B are diagrams illustrating example methods of dividing a target pitch shift value into a first pitch shift value and a second pitch shift value based on a pitch shift embedding table and at least one index value included therein according to various embodiments.

With reference to FIG. 4A, the first pitch shift value may be an integer value and the second pitch shift value may be a decimal value. If the target pitch shift value 310-1 is −1.4, the processor 120 may identify −1 which is an index value 420 closest to −1.4 among index values 410, 420 included in the pitch shift embedding table through the target pitch shift value division module 320-1 as the first pitch shift value 330-1. The processor 120 may identify −0.4 which is a difference between the identified first pitch shift value 330-1 and the target pitch shift value 310 as the second pitch shift value 330-2.

With reference to FIG. 4B, if the target pitch shift value 310-2 is −1.6, the processor 120 may identify −2 which is an index value 420 closest to a −1.6 among index values 410, 420 included in the pitch shift embedding table through the target pitch shift value division module 320-1 as the first pitch shift value 330-1. The processor 120 may identify 0.4 which is a difference between the identified first pitch shift value 330-1 and the target pitch shift value 310 as the second pitch shift value 330-2.

The processor 120 may identify a pitch shift embedding value 340 which is a vector value on the virtual space corresponding to the first pitch shift value 330-1 through the pitch shift embedding module 330-2.

The processor 120 may shift or control a pitch among feature information 300 of the voice data based on the second pitch shift value through the pitch shift module 320-3. The processor 120 may update a feature related to the pitch of the voice data shifted by the pitch shift module 320-3 through a feature update module 320-4. As the above, the processor 120 may shift and update the feature related to the pitch among feature information 300 of the voice data through the pitch shift module 320-3 and the feature update module 320-4, thereby obtaining second voice data and identifying a pitch embedding value 350 which is a vector value on the virtual space corresponding to a pitch of the second voice data. Here, the processor 120 may control an additional pitch shift embedding module besides the pitch shift module 320-3 and the feature update module 320-4 to identify the pitch embedding value 350.

The processor 120 may obtain third voice data to which a pitch of the first voice data is shifted based on the pitch shift embedding value 340 and the pitch embedding value 350 through a vector concatenate module 320-5, which extends a vector dimension by connecting or combining different vector values. Here, the processor 120 may combine a vector value together corresponding to the updated feature information of the voice data output from the feature update module 320-4 through the vector concatenate module 320-5 besides the pitch shift embedding value 340 and the pitch embedding value 350.

For example, the processor 120 may obtain metadata based on the pitch shift embedding value 340 and the pitch embedding value 350 through the vector concatenate module 320-5. The processor 120 does not necessarily combine the pitch shift embedding value 340 with the pitch embedding value 350 through the vector concatenate module 320-5 and may combine the pitch shift embedding value 340 with the pitch embedding value 350 through other additional devices.

The metadata may be data obtained by the processor 120 performing any operation (e.g. a vector operation, four fundamental arithmetic operations, a log operation, a differential operation, etc.) with respect to the pitch shift embedding value 340 and the pitch embedding value 350.

The processor 120 may obtain the third voice data by encoding metadata in a frame unit through an encoder 320-6 and decode metadata encoded through a decoder 320-7 in a sample unit. The decoder 320-7 is a probabilistic model for generating a sample, wherein the processor 120 may generate a signal through sampling based on the probabilistic model through the decoder 320-7.

The encoder 320-6 may be implemented based on a convolutional neural network (CNN) and a deep neural network (DNN) and the decoder 320-7 may be implemented based on a recurrent neural network (RNN), the CNN, or the DNN.

In case that the encoder 320-6 is LPCnet, its network may be based on a frame rate network (FRN) which encodes metadata in a frame unit (e.g. 10 ms) and In case that the decoder 320-7 is LPCnet, its network may be based on a sample rate network (SRN) which decodes the encoded metadata in a sample unit.

As aforementioned, the processor 120 may obtain synthetic voice data 360 by shifting a pitch included in the feature information 300 of the voice data through a hybrid pitch shift embedding model (hereinafter referred to as a pitch shift embedding model) including a plurality of modules, an encoder, and a decoder.

The processor 120 does not simply shift a pitch of the voice data according to the target pitch shift value 230 through one pitch shift module 240-1 and may more exactly and specifically shift a pitch of the voice data by dividing the target pitch shift value 310 into the first pitch shift value 330-1 and the second pitch shift value 330-2 based on the pitch shift embedding table.

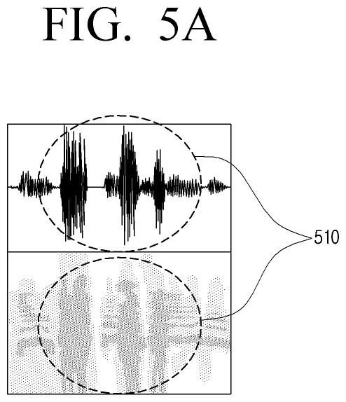

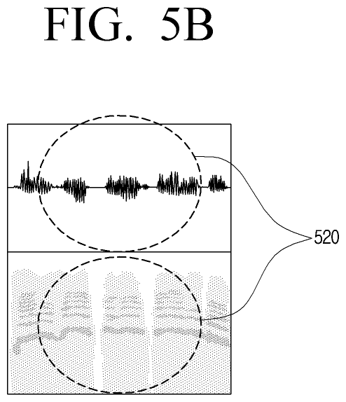

When comparing to the related art, the performance improvement of the pitch shift method according to an embodiment of the disclosure may be described through a spectrogram of FIGS. 5A and 5B.

FIG. 5A is a spectrogram of voice data of which a pitch is shifted by an electronic device 100 according to the related art.

With reference to FIG. 5A, it is observed that the voice data of which a pitch is shifted by the electronic device 100 according to the related art has hardened or damaged sound quality in a section 510 where the pitch is shifted.

FIG. 5B is a spectrogram of voice data of which a pitch is shifted by an electronic device 100 according to various embodiments.

With reference to FIG. 5B, it is observed that the voice data of which a pitch is shifted by the electronic device 100 according to an embodiment of the disclosure does not have hardened or damaged sound quality but has a regular and even pattern in a section 520 where the pitch is shifted.

Therefore, the processor 120 may more exactly and specifically shift a pitch in a range of all values of real numbers with respect to the voice data and may reduce the number of the pitch shift embedding value by utilizing the pitch shift embedding table and thus may minimize and/or reduce learning data required to learn the pitch shift embedding model 320.

The aforementioned pitch shift embedding model 320 may be implemented through a neural network model. If the pitch shift embedding model 320 is implemented as the neural network model, each module included in the pitch shift embedding model 320 may include a node having one or more weight values and a layer. The neural network model may include the CNN, the DNN, the RNN, a bidirectional recurrent deep neural network (BRDNN), or the like, but it is not limited thereto.

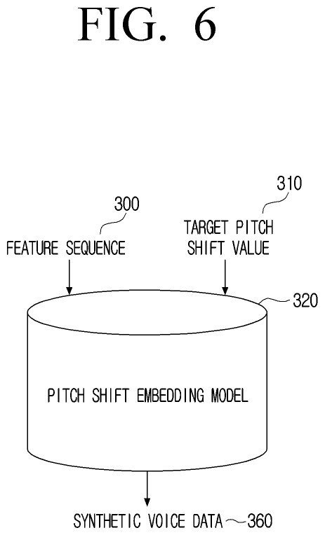

FIG. 6 is a diagram illustrating an example pitch shift embedding model controlled by the electronic device 100 according to various embodiments.

With reference to FIG. 6, the processor 120 may obtain synthetic voice data 360 based on the output vector value by inputting feature information 300 of voice data and a target pitch shift value 310 into a neural network model (e.g., a pitch shift embedding model 320).

The processor 120 may obtain reconstruction information for reconstructing input data (e.g. the feature information 300 of the voice data and the target pitch shift value 310), output data (e.g. a vector value on a virtual space), a synthetic voice data 360 obtained based on the output data, and a neural network model obtained based on the synthetic voice data 360.

The processor 120 may identify the input data of the pitch shift embedding model based on the feature information 300 of the first voice data and the target pitch shift value 310.

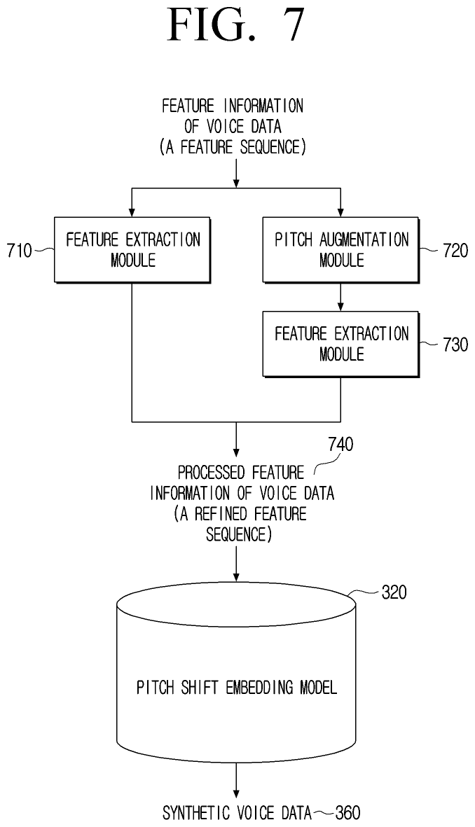

FIG. 7 is a diagram illustrating example learning of a pitch shift embedding model 320 controlled by an electronic device 100 according to various embodiments.

With reference to FIG. 7, the processor 120 may extract feature information from the first voice data through a feature extraction module (e.g., including various circuitry and/or executable program instructions) 710. The feature information 300 of the first voice data may include cepstrum, a pitch, or correlation.

The processor 120 may augment a pitch of the first voice data based on a target pitch shift value 310 through a pitch augmentation module (e.g., including various circuitry and/or executable program instructions) 720. The processor 120 may obtain fourth voice data of which a pitch is augmented from the first voice data based on the target pitch shift value 310.

When extracting and learning feature information from the fourth voice data of which the pitch is augmented, in performing control of the pitch, the feature information is different from feature information output from an acoustic model and thus an operation performance of controlling the pitch may be reduced in the case of learning this way.

The processor 120 may extract feature information from the fourth voice data obtained through a feature extraction module (e.g., including various circuitry and/or executable program instructions) 730.

The processor 120 may obtain processed feature information 740 of the voice data (a refined feature sequence) based on feature information extracted from the first voice data and feature information extracted from the fourth voice data and the processor 120 may identify the processed feature information 740 as the input data of the pitch shift embedding model 320.

The processor 120 may identify output data of the pitch shift embedding model based on the third voice data to which a pitch of the first voice data corresponding to an output vector value of the pitch shift embedding model 320 is shifted.

The processor 120 may identify a loss of the electronic device 100 including the pitch shift embedding model 320 based on the input data and the output data.

The processor 120 may learn the pitch shift embedding model 320 and the pitch shift embedding table based on the input data, the output data, and the loss. The loss may include, for example, a cross entropy loss.

The processor 120 may learn them by controlling a weight value included in the neural network model constructing the pitch shift embedding model 320 based on the input data, the output data, and the loss.

In this case, the memory 110 may store the pitch shift embedding model 320, output data (e.g. a vector value on a virtual space and third voice data) obtained based on input data (e.g. feature information 300 of voice data and the target pitch shift value 310) input into the pitch shift embedding model 320, use information obtained based on the output data, and reconstruction information for reconstructing a neural network model obtained based on the use information.

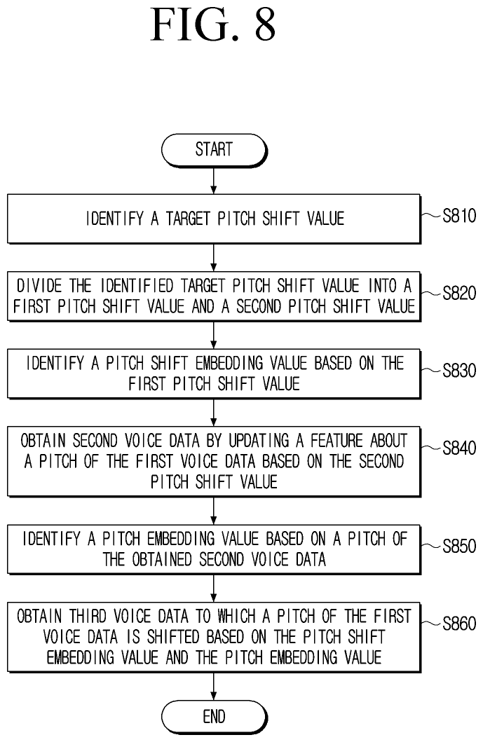

FIG. 8 is a flowchart illustrating an example operation of an electronic device 100 according to various embodiments.

The electronic device 100 may identify a target pitch shift value 310 for shifting a pitch of voice data (S810). The processor 120 may divide the target pitch shift value 310 identified, for example, through the target pitch shift value division module 320-1 into the first pitch shift value 330-1 and the second pitch shift value 330-2 (S820).

The electronic device 100 may divide the target pitch shift value 310 into the first pitch shift value 330-1 and the second pitch shift value 330-2 based on a pitch shift embedding table.

For example, the electronic device 100 may identify an index value closest to the target pitch shift value 310 among at least one index value included in the pitch shift embedding table as the first pitch shift value 330-1 and may identify a difference between the identified first pitch shift value 330-1 and the target pitch shift value 310 as the second pitch shift value 330-2.

The first pitch shift value 330-1 is an integer value and the second pitch shift value 330-2 is a decimal value.

The electronic device 100 may identify a pitch shift embedding value 340 based on the first pitch shift value 330-1 through the pitch shift embedding module 320-2 (S830).

The electronic device 100 may obtain second voice data by updating a feature about a pitch of the first voice data based on the second pitch shift value 330-2 through the pitch shift module 320-3 and the feature update module 320-4 (S840).

The electronic device 100 may identify a pitch embedding value 350 based on a pitch of the second voice data obtained through the pitch shift module 320-3 and the feature update module 320-4 (S850).

The electronic device 100 may obtain third voice data including synthetic voice data 360 to which a pitch of the first voice data is shifted based on the pitch shift embedding value 340 and the pitch embedding value 350 through the vector concatenate module 320-5 (S860).

A function related to AI according to the disclosure operates through the processor 120 and the memory 110 of the electronic device 100.

The processor 120 may be configured as one or a plurality of processors 120. One or the plurality of processors 120 may include at least one of a central processing unit (CPU), a graphic processing unit (GPU), or a neural processing unit (NPU) but are not limited to the aforementioned examples of the processor 120.

The CPU may refer to a generic-purpose processor 120 which may perform not only a general operation but also an AI operation and may efficiently execute a complex program through a multilayer cache structure. The CPU is advantageous for a series processing method capable of an organic connection between the previous calculation result and the next calculation result through a sequential calculation. The generic-purpose processor 120 is not limited to the aforementioned example excluding a case of indicating the aforementioned CPU.

The GPU may refer to the processor 120 for a mass operation such as a floating point operation used for graphic processing and may integrate cores massively to perform the mass operation in parallel. In particular, the GPU may be advantageous for a parallel processing method such as a convolution operation compared to the CPU. Also, the GPU may be used as an auxiliary processor 120 (a co-processor) for compensating for a function of the CPU. The processor 120 for the mass operation is not limited to the aforementioned example excluding a case of indicating the aforementioned GPU.

The NPU may refer to the processor 120 specific to an AI operation using an artificial neural network and may be implemented such that each layer constructing the artificial neural network is hardware (e.g. silicon). Here, the NPU is designed to be specific to requirements of a manufacturer and thus its degree of freedom is lower than that of the CPU or the GPU. However, the NPU may efficiently process the AI operation required by the manufacturer. The NPU as the processor 120 specific to the AI operation may be implemented in various forms such as a tensor processing unit (TPU), an intelligence processing unit (IPU), and a vision processing unit (VPU). The AI processor 120 is not limited to the aforementioned examples excluding a case of indicating the aforementioned NPU.

One or the plurality of processors 120 may be implemented as a system on chip (SoC). The SoC may further include memory 110 and a network interface such as a bus for a data communication between the processor 120 and the memory 110 besides one or the plurality of processors 120.

If the SoC included in the electronic device 100 includes the plurality of processors 120, the electronic device 100 may perform an operation related to AI (e.g. an operation related to learning or inference of an AI model) using a partial processor 120 among the plurality of processors 120. For example, the electronic device 100 may perform the operation related to AI using at least one of the GPU, the NPU, the VPU, the TPU, or the hardware accelerator specific to the AI operation such as a convolution operation and a matrix multiplication operation among the plurality of processors 120. The above is merely an example and it will be apparent that the operation related to AI may be processed using the generic-purpose processor 120 such as the CPU.

The electronic device 100 may perform the operation about a function related to the AI using a multicore (e.g. a dual core, a quad core, etc.) included in one processor 120. In particular, the electronic device 100 may perform the AI operation such as the convolution operation and the matrix multiplication operation in parallel using the multicore included in the processor 120.

One or the plurality of processors 120 controls to process input data according to a predefined operation rule or an AI model stored in the memory 110. The predefined operation rule or the AI model is made by learning.

Made by learning may refer, for example, to the predefined operation rule or the AI model having a desired characteristic being made by applying learning algorithm to various learning data. This learning may be performed in a device itself where the AI according to the disclosure is performed and may be performed through a separate server/system.

The AI model may include a plurality of neural network layers. At least one layer has at least one weight value and performs an operation of the layer through an operation result of the previous layer and at least one defined operation. Examples of the neural network are a convolutional neural network (CNN), a deep neural network (DNN), a recurrent neural network (RNN), a restricted Boltzmann machine (RBM), a deep belief network (DBN), a bidirectional recurrent deep neural network (BRDNN), a Deep Q-Network, a transformer, or the like. The neural network of the disclosure is not limited to the aforementioned examples unless explicitly indicated.

The learning algorithm may refer to a method that a certain object device (e.g. a robot) is trained using various learning data such that the certain object device may make or predict a decision by itself. Examples of the learning algorithm are supervised learning, unsupervised learning, semi-supervised learning, or reinforcement learning. The learning algorithm of the disclosure is not limited the aforementioned examples unless explicitly indicated.

According to an embodiment, a method according to various examples disclosed in the disclosure may be provided to be included in a computer program product. The computer program product may be traded between a seller and a buyer as goods. The computer program product may be distributed on-line in a form of the machine-readable storage medium (e.g. compact disc read only memory (CD-ROM)) or distributed (e.g. downloaded or uploaded) via an application store (e.g. Play Store™) or directly between two user devices (e.g. smart phones). In the case of on-line distribution, at least part of the computer program product (e.g. a downloadable app) may be stored at least temporarily or may be generated temporarily in the machine-readable storage media such as memory of a server of a manufacturer, a server of an application store, or a relay server.

While the present has been illustrated and described with reference to various example embodiments, it will be understood that the disclosure is not limited to the aforementioned various examples and various modifications may be implemented by those skilled in the art without deviating from the gist of the disclosure including the appended claims and their equivalents. It will also be understood than any of the embodiment(s) described herein may be used in conjunction with any other embodiment(s) described herein.

What is claimed is:

1. An electronic device, comprising:
memory storing at least one instruction; and
at least one processor, comprising processing circuitry, individually and/or collectively, configured to execute the at least one instruction,
wherein at least one processor, individually and/or collectively, is configured to:
identify a target pitch shift value for shifting a pitch of voice data;
divide the identified target pitch shift value into a first pitch shift value and a second pitch shift value;
identify a pitch shift embedding value based on the first pitch shift value;
obtain second voice data by updating a feature of a pitch of first voice data based on the second pitch shift value;
identify a pitch embedding value based on a pitch of the obtained second voice data; and
obtain third voice data to which the pitch of the first voice data is shifted based on the pitch shift embedding value and the pitch embedding value.

2. The method of claim 1, wherein at least one processor, individually and/or collectively, is configured to:
divide the target pitch shift value into the first pitch shift value and the second pitch shift value based on a pitch shift embedding table.

3. The method of claim 2, wherein at least one processor, individually and/or collectively, is configured to:
identify an index value closest to the target pitch shift value among at least one index value included in the pitch shift embedding table as the first pitch shift value; and identify a difference between the identified first pitch shift value and the target pitch shift value as the second pitch shift value.

4. The method of claim 3, wherein the first pitch shift value is an integer value and the second pitch shift value is a decimal value.

5. The method of claim 1, wherein at least one processor, individually and/or collectively, is configured to:
obtain metadata based on the pitch shift embedding value and the pitch embedding value;
encode the metadata in a frame unit; and
obtain the third voice data by decoding the encoded metadata in a sample unit.

6. The method of claim 1, wherein at least one processor, individually and/or collectively, is configured to:
identify input data of a pitch shift embedding model based on information about the feature of the first voice data and the target pitch shift value;
identify output data of the pitch shift embedding model based on the third voice data;
identify a loss of the pitch shift embedding model based on the input data and the output data; and
learn the pitch shift embedding model and the pitch shift embedding table based on the input data, the output data, and the loss.

7. The method of claim 6, wherein at least one processor, individually and/or collectively, is configured to:
extract feature information from the first voice data;
obtain fourth voice data by augmenting the pitch of the first voice data based on the target pitch shift value;
extract feature information from the obtained fourth voice data; and
identify input data of the pitch shift embedding model based on the feature information extracted from the first voice data and the feature information extracted from the fourth voice data.

8. The method of claim 6, wherein the feature information of the first voice data includes cepstrum, the pitch, or correlation.

9. A method of controlling an electronic device, comprising:
identifying a target pitch shift value for shifting a pitch of voice data;
dividing the identified target pitch shift value into a first pitch shift value and a second pitch shift value;
identifying a pitch shift embedding value based on the first pitch shift value;
updating a feature of a pitch of first voice data based on the second pitch shift value and obtaining second voice data;
identifying a pitch embedding value based on a pitch of the obtained second voice data; and
obtaining third voice data to which the pitch of the first voice data is shifted based on the pitch shift embedding value and the pitch embedding value.

10. The method of claim 9, wherein the dividing includes:
dividing the target pitch shift value into the first pitch shift value and the second pitch shift value based on a pitch shift embedding table.

11. The method of claim 10, wherein the dividing includes:
identifying an index value closest to the target pitch shift value among at least one index value included in the pitch shift embedding table as the first pitch shift value; and
identifying a difference between the identified first pitch shift value and the target pitch shift value as the second pitch shift value.

12. The method of claim 11, wherein the first pitch shift value is an integer value and the second pitch shift value is a decimal value.

13. The method of claim 9, wherein obtaining the third voice data includes:
obtaining metadata based on the pitch shift embedding value and the pitch embedding value;
encoding the metadata in a frame unit; and
decoding the encoded metadata in a sample unit and obtaining the third voice data.

14. The method of claim 9, wherein the method further includes:
learning a pitch shift embedding model;
wherein the learning includes:
identifying input data of the pitch shift embedding model based on feature information of the first voice data and the target pitch shift value;
identifying output data of the pitch shift embedding model based on the third voice data;
identifying a loss of the pitch shift embedding model based on the input data and the output data; and
learning the pitch shift embedding model and the pitch shift embedding table based on the input data, the output data, and the loss.

15. The method of claim 14, wherein the learning includes:
obtaining fourth voice data by augmenting the pitch of the first voice data based on the target pitch shift value;
extracting feature information from the obtained fourth voice data; and
identifying input data of the pitch shift embedding model based on the feature information extracted from the first voice data and the feature information extracted from the fourth voice data.
